(19) United States
(12) Patent Application Publication
(10) Pub. No.: US 2026/0358298 A1
(43) Pub. Date: Nov. 12, 2026

(54) NON-DESTRUCTIVE TEST (NDT) FLAW AND ANOMALY DETECTION

(71) Applicant: Evident Canada, Inc., Québec (CA)

(72) Inventors: Ivan C. Kraljic, Saint-Gervais (CA); Alexandre Moreau, Sainte-Catherine-De-La-Jacques-Cartier (CA); Guillaume Painchaud-April, L'Ancienne-Lorette (CA)

(21) Appl. No.: 19/122,029

(22) PCT Filed: Oct. 30, 2023
(86) PCT No.: PCT/CA2023/051443

§ 371 Date: Apr. 17, 2025

Related U.S. Application Data
(60) Provisional application No. 63/381,732, filed on Oct. 31, 2022.

(51) Int. Cl. G01N 29/06; G01N 29/04; G01N 29/44; G01S 15/89

(52) U.S. Cl. CPC G01N 29/069; G01N 29/043; G01N 29/4481; G01S 15/8915; G01N 2291/0289

(57) ABSTRACT

A non-destructive test apparatus can include a probe assembly configured to acquire inspection data using an acoustic technique. The probe assembly can be communicatively coupled with at least one processor circuit, the processor circuit configured to apply a machine learning model as shown and described herein. For example, such a machine learning model can be used to detect a flaw or other feature when the machine learning model is applied to acoustic imaging data constructed using the acoustic inspection data acquired using the probe assembly. Approaches are also disclosed herein for performing data assessment, such as to evaluate whether acquired imaging data deviates from characteristics of a reference image population, or to evaluate a quality of flaw annotations applied to imaging data, or combinations thereof.

### CLAIM OF PRIORITY

This patent application claims the benefit of priority of Kraljic, et al., U.S. Provisional Patent Application No. 63/381,732, titled “TURBINE BLADE FLAW DETECTION,” filed on Oct. 31, 2022 (Attorney Docket No. 6409.241PRV), which is hereby incorporated by reference herein in its entirety.

### FIELD OF THE DISCLOSURE

This document pertains generally, but not by way of limitation, to apparatus and techniques for non-destructive inspection such as facilitating acoustic inspection, and more particularly, to apparatus and techniques for performing automated or semi-automated detection of flaws or anomalies in acoustic imaging data obtained for non-destructive inspection of objects such as composite structures.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

### SUMMARY OF THE DISCLOSURE

Non-destructive testing techniques can be used to inspect objects in relation to a wide variety of applications, such as in relation to manufacturing or field inspection. Acoustic inspection is one such approach, using one or more transducers to direct acoustic energy into a target and then receiving and processing any reflected energy. The received signals can be processed and imaged to facilitate inspection and evaluation. For example, such ultrasonic inspection data can be processed to provide time-series or imaging data in specified formats such A-scan (e.g., one-dimensional amplitude vs. time), B-scan (two-dimensional amplitude vs. time), C-scan (e.g., two-dimensional plan view of amplitude corresponding to cross-section parallel to a scanning surface), D-scan (e.g., end-view corresponding to cross-section perpendicular to a scanning surface), or sector scan. Acquired acoustic inspection imaging data is generally reviewed manually (e.g., by user inspection of a presentation of imaging) to identify indications of flaws, defects, or other anomalies. However, reviewing large volumes of imaging data can be time and labor intensive.

The present inventors have recognized, among other things, that while various techniques have been investigated to help automate aspects of non-destructive inspection and evaluation, obtaining consistently accurate automated detection and characterization of flaws or anomalies remains challenging. The present disclosure relates generally to techniques for facilitating automated evaluation of non-destructive inspection data, such as using machine learning techniques. Such techniques can enhance inspection efficiency, such as by providing automated flaw annotation in acquired acoustic inspection imaging data. Applications for such annotation can include flaw annotation in acquired acoustic inspection data related to composite structure inspection (e.g., inhomogeneous composite structures such as airfoils, including, for example, wind turbine blades).

Various techniques herein can also be used to assess imaging data, such as for purposes of building or augmenting a corpus of training data used for establishing one or more machine learning models, or for identifying that in a deployed instance, input data to such models is incongruent with prior data used for training. Machine learning models can also be used for such assessment. Data assessment techniques can be used to evaluate drift in either input data provided to such models, or output data, such as whether indications of probable flaws or anomalies provided by outputs of such models are showing signs of drift or other behavior warranting attention.

In an example, a system can be configured to perform a machine-implemented method, the method comprising receiving a first image representative of acquired acoustic inspection data, the image comprising pixel values corresponding to received acoustic echo amplitude versus time within an object under test, and versus a scan axis, generating a flaw map indicative of probable flaw locations corresponding to respective locations in the image using the received image and a neural-network-based flaw detector, and generating an indication versus location in the scan axis indicative of an anomaly using the received image and a neural-network-based anomaly detector. The image can be, for example, a D-scan image comprising an end view of an object under test, such as a composite structure. For example, the composite structure can be an airfoil, such as a wind turbine blade.

In an example, a system can be configured to perform a machine-implemented method, the method comprising receiving multiple images of acquired acoustic inspection data including a label defining a flaw region in a first image amongst the multiple images, the multiple images comprising pixel values corresponding to received acoustic echo amplitude versus time within an object under test, and versus a scan axis, evaluating a metric corresponding to the flaw region in the first image and a corresponding region in one or more adjacent slices from amongst the multiple images to define a bounding region extending in three dimensions, and transmitting or presenting the metric for use in determining whether the label defining the flaw region corresponds to a real flaw. The image can be, for example, a D-scan image comprising an end view of an object under test, such as a composite structure. For example, the composite structure can be an airfoil, such as a wind turbine blade.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2 illustrates generally an example comprising a technique, such as a machine-implemented method, for applying a machine learning model to images representative of acquired acoustic inspection data.

FIG. 3A shows an illustrative example of an image corresponding to an acoustic acquisition.

FIG. 3B shows an illustrative example of an image comprising a flaw map corresponding to the image of FIG. 3A, such as can be output from a machine learning model.

FIG. 3C shows the flaw map of FIG. 3B overlaid on the image of FIG. 3A, such as can be presented to a user to aid in evaluating an inspection result.

FIG. 4A shows an illustrative example of a technique, such as a machine-implemented method, for applying machine learning model that can be used to generate an anomaly score.

FIG. 4B shows an illustrative example of a series of anomaly scores versus an index location, such as illustrating respective index locations containing anomalies (either corresponding to flaws or corresponding to anomalies such as inspection configuration anomalies), and such as can be generated using the technique shown in FIG. 4A.

FIG. 4C shows an illustrative example of a series of anomaly scores versus an index location, such as illustrating respective index locations containing anomalies (either corresponding to flaws or corresponding to anomalies such as inspection configuration anomalies), and such as can be generated using another machine learning model.

FIG. 5A illustrates generally a technique, such as a machine-implemented method, for establishing (e.g., “training”) a machine learning model.

FIG. 5B illustrates generally a technique, such as a machine-implemented method, for deploying a machine learning model including drift monitoring.

FIG. 5C shows an illustrative example that can include using a statistical distribution as an indication of a degree of similarity between a population of images corresponding to acquired acoustic imaging data versus a reference population of images, where in the example of FIG. 5C, the acquired acoustic imaging data and the reference population are similar.

FIG. 5D shows an illustrative example that can include using a statistical distribution as an indication of a degree of similarity between a population of images corresponding to acquired acoustic imaging data versus a reference population of images, where in the example of FIG. 5C, the acquired acoustic imaging data and the reference population are different indicating either drift or another anomaly.

FIG. 5E shows an illustrative example that can include using principal component analysis (PCA) to generate a reconstruction quality metric as an indication of a degree of similarity between a population of images corresponding to acquired acoustic imaging data versus a reference population of images, and plotted versus index location (e.g., end-view location).

FIG. 6 illustrates generally a technique, such as a machine-implemented method, for assessing quality of a flaw annotation in acoustic imaging data.

FIG. 7A shows an illustrative example of an image corresponding to an acoustic acquisition, and a corresponding flaw annotation.

FIG. 7B shows an illustrative example of image slices adjacent to an image having a flaw annotation, and a corresponding extension of a bounding box as shown in FIG. 7A extended to one or more adjacent slices, such as for assessing quality of a flaw annotation using a technique as described in FIG. 6.

FIG. 7C shows an illustrative example comprising a value of a metric versus index location, with a range of index location values corresponding to the extension of the bounding box of FIG. 7B in the index axis.

FIG. 7D shows an illustrative example comprising a plot of different metric values that can be used for assessing a quality of a flaw annotation, such as including an indication of a range of index location values corresponding to the extension of the bounding box of FIG. 7B in the index axis.

FIG. 8 shows an architecture and related workflows that can include establishing training data for training one or more machine learning models, assessing data to be used as an input to one or more such machine learning models, applying one or more such models, and assessing an output from such models.

FIG. 9 illustrates a block diagram of an example comprising a machine 900 upon which any one or more of the techniques (e.g., methodologies) discussed herein may be performed.

### DETAILED DESCRIPTION

Non-destructive testing of manufactured structures can be performed using an acoustic technique, such as involving ultrasonic inspection using a phased-array transducer architecture and associated processing (e.g., beamforming and imaging). For large structures (e.g., metal or composite), an associated volume of acquired acoustic inspection data can be very large for each article being inspected and across a production lot of such articles. For example, in inspection of composite structures such as wind turbine blades, such a volume can include hundreds of thousands of D-scans produced using acoustic inspection, showing end-views of the structures being inspected.

Qualified human inspectors generally spend many hours to review such data, generally using a manual approach involving inspecting images for flaw indications and annotating images to identify such indications. Since imaging related to acoustic inspection can have high variability and complex features, it is challenging to develop software-based techniques to automatically identify flaws or indicia of inspection configuration anomalies with acceptable accuracy. The present inventors have, among other things, developed techniques to use a machine learning approach to augment or accelerate human inspection, such as enhancing flaw detection accuracy (e.g., sensitivity). Such an approach can also include use of techniques to flag anomalies associated with an inspection configuration.

One approach for machine learning can include a “deep learning” technique. Generally, deep learning involves training one or several neural network models on large amounts of data. The techniques described herein can use deep learning for flaw detection and classification applied to phased-array data, such as in a manufacturing context or in relation to field inspection, as illustrative examples.

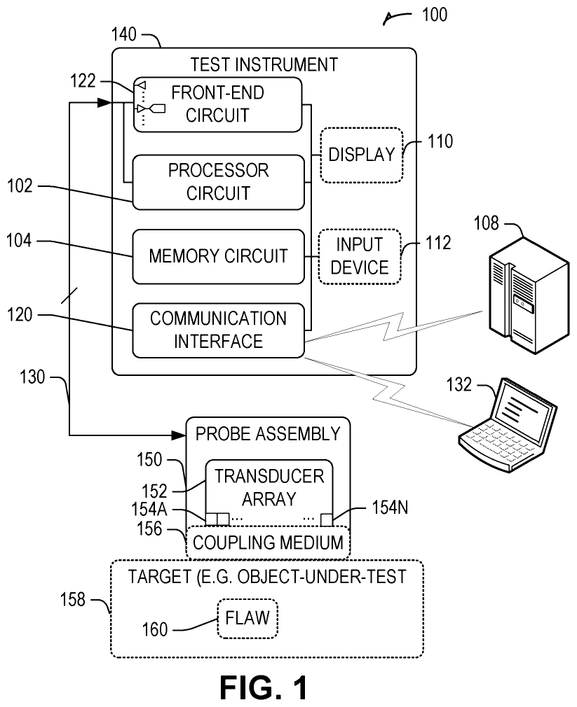

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

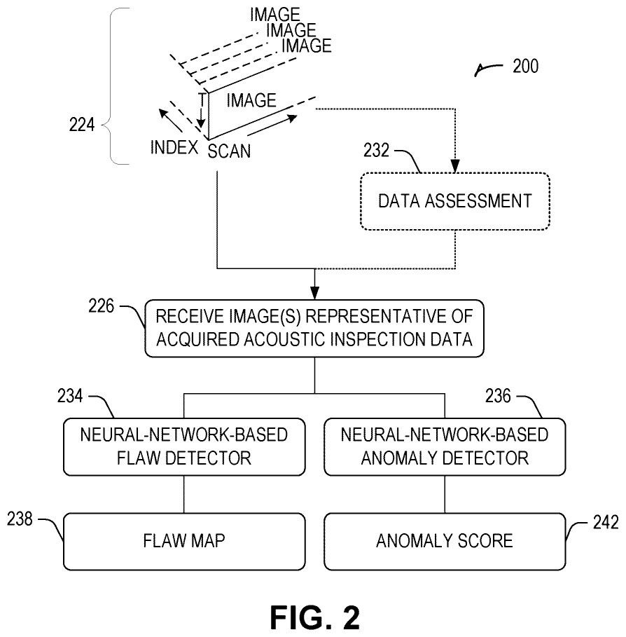

FIG. 2 illustrates generally an example comprising a technique 200, such as a machine-implemented method, for applying a machine learning model to images representative of acquired acoustic inspection data. One or more images 224 representative of acquired acoustic inspection data can be received at 226. For example, if the technique 200 is implemented using a networked computing facility such as a cloud computing facility, the one or more images 224 can be transmitted to the networked computing facility for evaluation. At 234, a neural-network based detector (e.g., a model instance, or a pipeline or other topology of multiple model instances) can be applied to the one or more images 224, such as to provide a flaw map at 238 indicative of probable flaw locations, such as corresponding to locations in the one or more images 224. In parallel, a neural-network-based anomaly detector (e.g., a model instance, or a pipeline or other topology of multiple such model instances) can be applied to the one or more images 224 at 236, such as to generate an anomaly score at 242. The anomaly score can correspond to a probability or other metric indicative that an anomaly in the instrument configuration has occurred (e.g., a change in instrument configuration or other deviation with respect to the training data). The anomaly could be related to a flaw, but would broadly indicate other factors (e.g., an anomaly other than a flaw defined by the flaw detector) such as measurement probe configuration (e.g., incorrect or different wedge or probe height than was used in training a model, couplant issue such as wrong water column or different couplant medium than was used in training, different probe assembly, etc.), or instrument configuration (e.g., incorrect parameters used in software or firmware setup, or parameters that differ from those used for training such as different propagation model or mode, gain, or velocity profile). The anomaly detector could also indicate an anomaly if an intentional or accidental change occurs in the materials or process used for fabricating the object under test, versus the process and materials used for training the anomaly detector model. The present inventors have recognized that providing a separate anomaly score can help to identify (e.g., cross-check) whether detected flaws as indicated by the flaw map 238 are likely to be false positives, or that a lack of detected flaws as indicated by the flaw map 238 may instead be due to configuration or setup issues, or other factors such as model drift, manufacturing process drift, or inspection process drift.

Optionally, at 232, a data assessment can be performed on the one or more images 224, such as to assess whether respective images within a group of input images are suitable for further automated analysis or should be disqualified. For example, such review can be performed by trained inspectors to remove images that are likely to result in flawed analysis results or that contain obvious deficiencies. In another approach, the data assessment at 232 can be automated, such as using statistical techniques, such as shown and described in relation to other examples herein (e.g., to determine whether a distribution associated with the one or more images 224 differs from some reference imaging data set, such as images used to the train the flaw detector or the anomaly detector).

As an illustrative (but non-limiting) example, the flaw detector can be implemented using a UNETR neural network topology to provide flaw detection and image segmentation of flaw locations contemporaneously by generating the flaw map at 238. As another illustrative (but non-limiting) example, an autoencoder or DevNet neural network topology can be used to provide the anomaly detection at 236, such as discussed below. A cascaded approach including a further down-stream machine learning model can also be used, such as using the anomaly score 242 as contextual input provided to another machine learning model instance along with the flaw map 238 to provide further machine-implemented flaw classification, detection, or to provide related supporting information such as a confidence score, indication of a potential false positive in the flaw map 238, or more global quality assessment.

Generally, in the approaches described in this document, human inspectors are not required to fully inspect raw data, and the flaw detection can be performed by at least one neural-network-based model (or multiple such models). A single neural-network-based model can be used as an anomaly detector, or a combination of models can be used (e.g., providing anomaly detection, flaw segmentation, or flaw classification, or combinations thereof). A probability and type of flaw can be generated such as using a combination of different model outputs, such as aggregated and presented as a flaw map 238. For example, the flaw map 238 can include an indication of a type of flaw by using a respective pixel characteristic corresponding to each respective type of flaw, or the flaw map 238 can include an indication of a probability of a flaw by using a respective pixel characteristic, or combinations thereof.

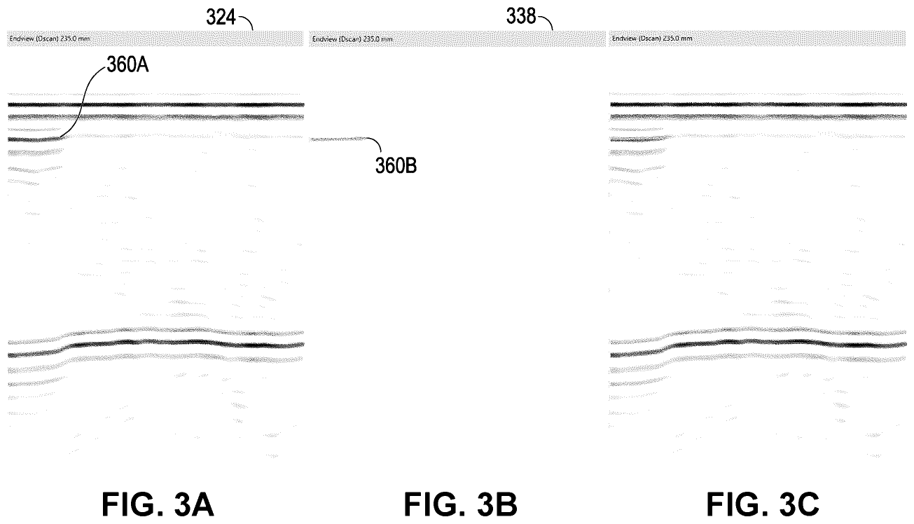

FIG. 3A shows an illustrative example of an image 324 corresponding to an acoustic acquisition. The image 324 of FIG. 3A is a D-scan end-view image, showing amplitude on a two-dimensional plot having a vertical axis depicting time-of-flight (or depth for a homogeneous object) and a horizontal axis depicting the scan axis. The image 324 was experimentally obtained from an acoustic acquisition, such as could be performed on a composite structure, such as an 84-meter composite wind turbine blade. A flaw indication 360A is apparent by inspection in the image 324. FIG. 3B shows an illustrative example of an image comprising a flaw map 338 corresponding to the image of FIG. 3A, such as can be output from a machine learning model. The flaw map 338 of FIG. 3B was generated by a neural-network-based flaw detector using a UNETR topology, showing a probable flaw location 360B. As discussed elsewhere herein, the image 324 need not be the only input image provided to the neural-network-based flaw detector to establish the probable flaw location 360B in the corresponding flaw map 338. For example, multiple D-scan images corresponding to different index locations (e.g., adjacent slices) could also be used in generating the flaw map 338 corresponding to the image 324. Use of phrases “scan” and “index” axes is by way of example, and other acoustic inspection imaging modalities can be used as mentioned elsewhere herein. FIG. 3B shows a two-dimensional flaw map 338, but other representations can be used. For example, a three-dimensional flaw map can be generated, such as overlaid on a geometric representation of the object under test, or overlaying a composite formed from multiple acoustic acquisitions (or both). FIG. 3C shows the flaw map of FIG. 3B overlaid on the image of FIG. 3A, such as can be presented to a user to aid in evaluating an inspection result.

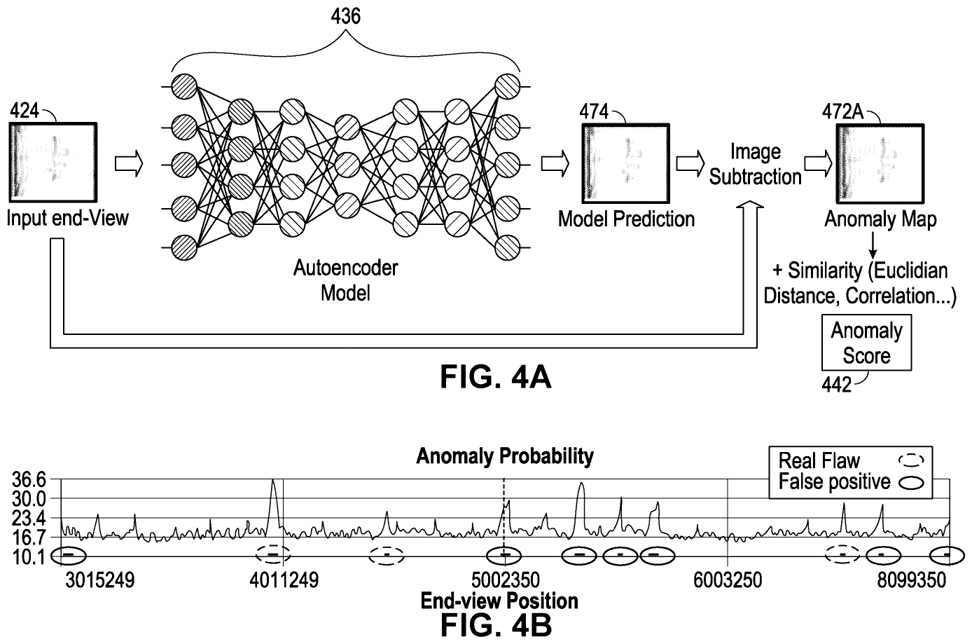

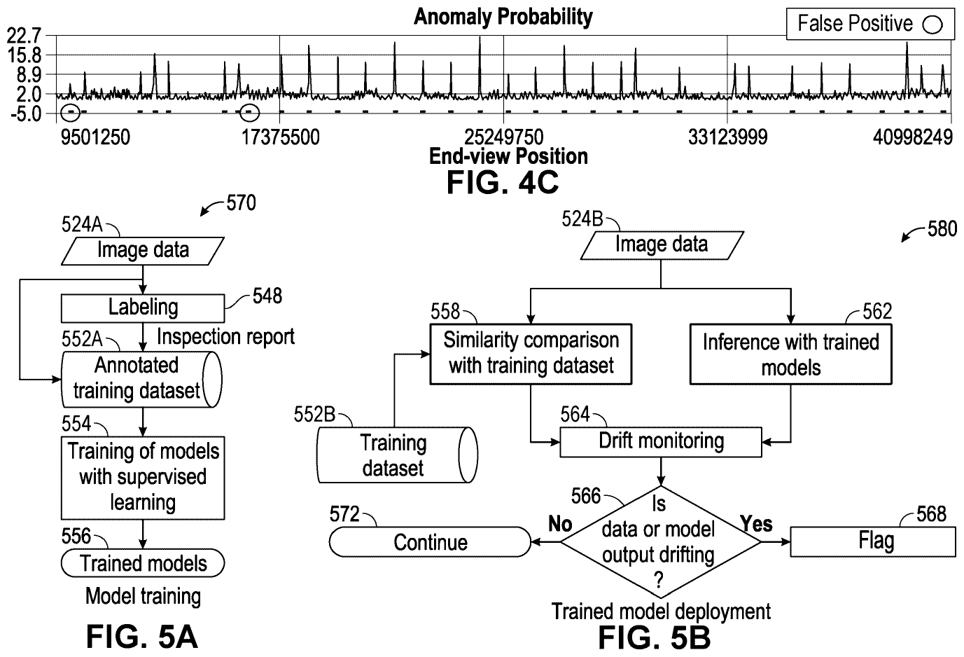

FIG. 4A shows an illustrative example of a technique, such as a machine-implemented method, for applying machine learning model that can be used to generate an anomaly score. The approach of FIG. 4A can be classified as an unsupervised learning approach. Manufactured articles generally exhibit a low level of defects from a statistical perspective, which means that most acquired acoustic inspection data does not include a flaw. One approach can include training an anomaly detection model 436 (e.g., autoencoder or Generative Adversarial Network) on known-good flawless data (unsupervised learning). Specifically, the model 436 can be trained using a specified mode of imaging for the input data, such as D-scan images (end views). The model can then be used to reconstruct known-good images, and it is generally unable to reconstruct images with flaws. By measuring a similarity between model input 424 and model output 474 (e.g., Euclidian distance, cross-correlation, or another metric), an anomaly score 442 can be generated. By applying a threshold, it is possible to tag as anomalous any data that deviates from the known-good data as indicated by the comparison of the anomaly score 442 with the threshold (e.g., a score exceeding the threshold indicates a probable anomaly). An anomaly map 472A can be generated to indicate the flaw location, such as by subtracting model input 424 and model output 474. The approach shown in FIG. 4A is one approach, and another approach can include generating the anomaly score 442 directly using the anomaly detection model 436 (e.g., without requiring an intermediate image comparison operation).

FIG. 4B shows an illustrative example of a series of anomaly scores versus an index location, such as illustrating respective index locations containing anomalies (either corresponding to flaws or corresponding to anomalies such as inspection configuration anomalies), and such as can be generated using the technique shown in FIG. 4A. The illustrative example of FIG. 4B was obtained using a trained autoencoder model deployed on new data (e.g., data that was not used for training the autoencoder). The plot of FIG. 4A represents a Euclidian distance between model output and model input. A threshold is applied to flag anomalies. Lines below the plot indicate regions where the anomaly score exceeds a specified threshold. With reference to ground truth, there are only three real flaws as noted in FIG. 4B, and many false positives. Despite a high false positive rate, unsupervised learning models can be deployed while collecting data and building a flaw database and the approach shown in FIG. 4B did not miss any real flaws.

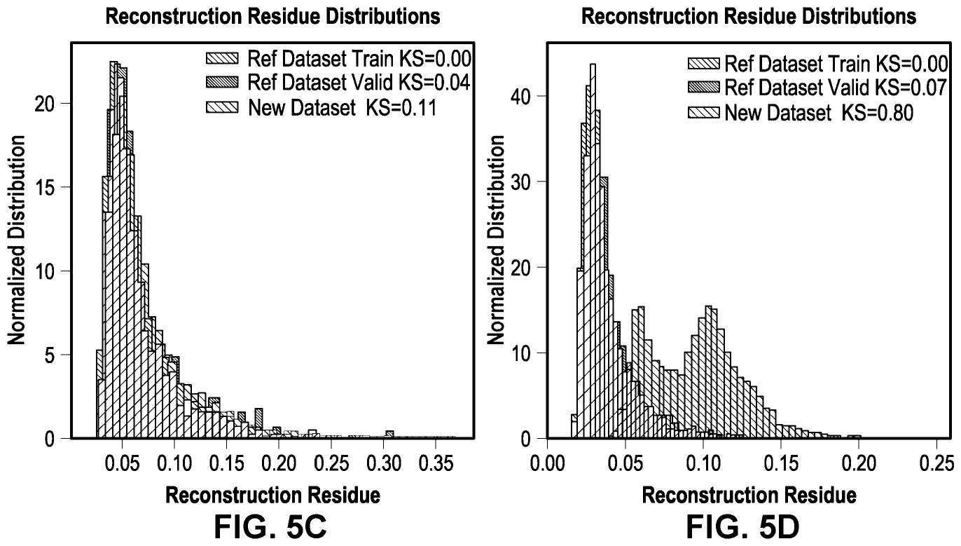

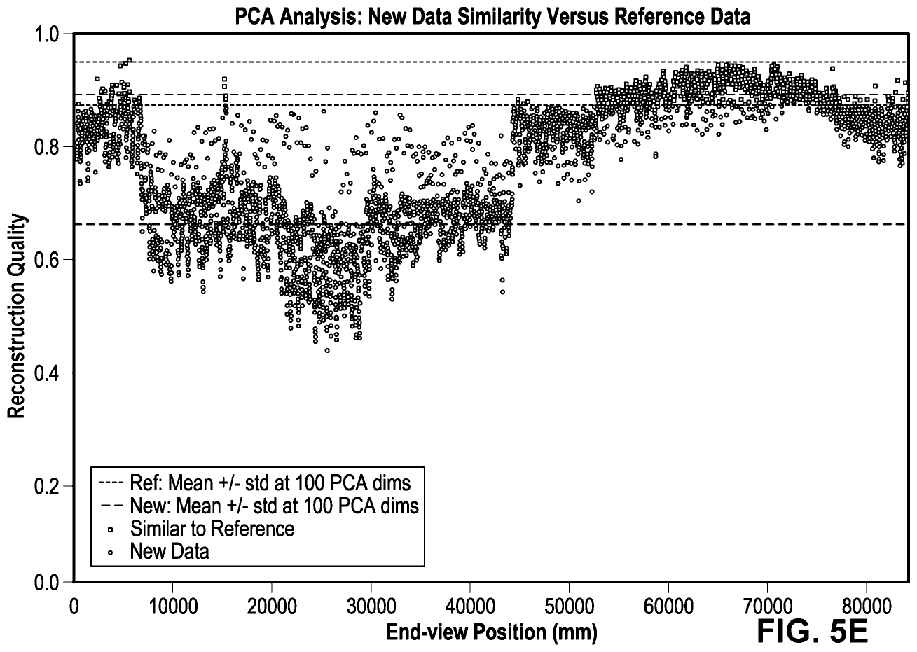

Other model topologies and training approaches can be used for either anomaly detection or flaw detection. For example, a supervised learning approach may provide better accuracy than unsupervised learning. In supervised learning, the training data is annotated (e.g., “labeled”): for example, data is tagged as representing a flaw or as having no flaw. More specific tagging can include tagging one or more of a flaw type or flaw location (or both). In an existing manufacturing facility with an inspection process done by humans, it is possible to deploy supervised learning to augment the inspection workflow. Model training can leverage the human inspection process to collect inspection reports to provide a body of training data. With these reports, acquiring acoustic inspection imaging data can be annotated and tagged as having a flaw or no flaw (or using other labels). This can be done manually, semi-automatically, or fully-automatically. Neural network models can then be trained on this annotated dataset, or such models can be enhanced, such as refined as more training data becomes available. Anomaly detection models, or other models such as flaw classifier or segmentation models can be targeted, as illustrative examples. A technique for such training is shown and discussed below in relation to FIG. 5A and a corresponding deployment of a trained model is shown and discussed below in relation to FIG. 5B.

FIG. 4C shows an illustrative example of a series of anomaly scores versus an index location, such as illustrating respective index locations containing anomalies (either corresponding to flaws or corresponding to anomalies such as inspection configuration anomalies), and such as can be generated using another machine learning model using a supervised learning approach. By contrast with FIG. 4B, the anomaly score and threshold comparison of FIG. 4C show a lower false positive rate. The anomaly detection model used for FIG. 4C, trained with supervised learning using a DevNet topology. Generally, as shown in FIG. 4C, index locations where an anomaly score exceeds a threshold can be flagged (e.g., indicated on a presentation to a user as a portion of a graphical user interface), or an alert can be generated, along with or instead of saving such score data accompanying the imaging data for further review.

FIG. 5A illustrates generally a technique 570, such as a machine-implemented method, for establishing (e.g., “training”) a machine learning model. Imaging data 524A can be received and at 548, manual or automated annotation of the imaging data 524A can be performed, such as to annotate flaw characteristics, such as an existence, class, or locus of a flaw in corresponding acquired acoustic inspection images of the imaging data 524A. Such annotation can be an output of an existing human inspection process in the form of a digital inspection report, such as then used for forming an annotated training dataset 552A. At 554, training of one or more corresponding machine learning models can be performed using a supervised learning approach, to provide one or more trained models 556. As discussed below and elsewhere herein, the annotated training dataset 552A need not include all labeled data from an inspection report, such as having certain images automatically or manually disqualified.

One potential challenge with supervised learning can be that a scarcity of flaws may exist in the data due to relatively low actual defect rates. It may take weeks or months to collect enough flaw data to train a model. One way of mitigating this is with data augmentation. Real or simulated flaws can be superimposed on known-good images, and models trained on an augmented dataset. The annotated training dataset 552A may be augmented using other approaches such as manipulating and duplicating respective images (stretching, shrinking, altering image characteristics such as hue, brightness, or contrast, or the like).

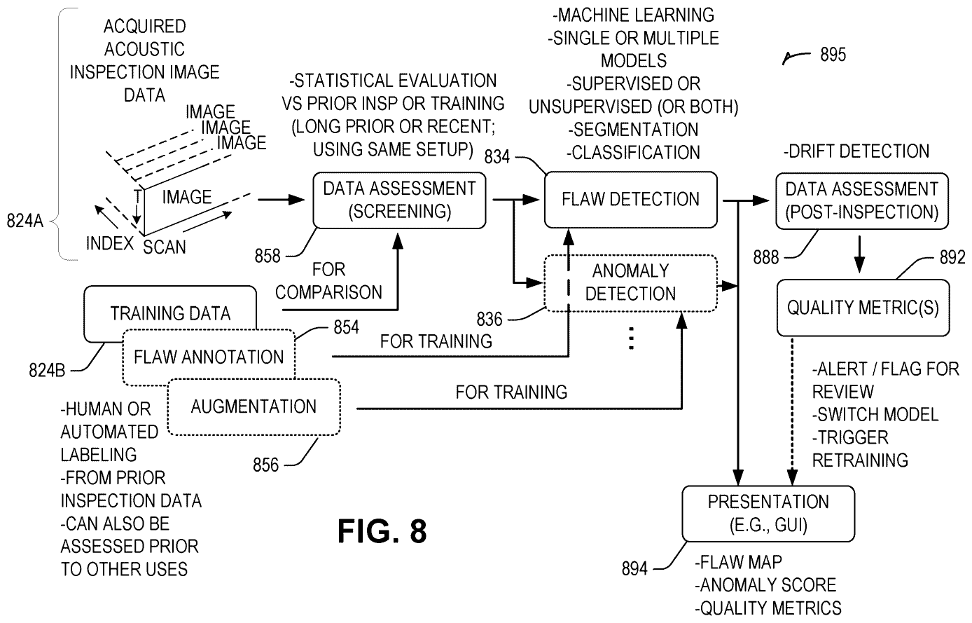

Behavior of machine-learning-based detection approaches may drift with time, particularly if models underlying such detection approaches are refined on an ongoing basis with new training data. The present inventors have recognized that such models can lose accuracy in a way that may be hard to detect. As mentioned above, a model deployment can include provisions to detect data drift. For example, new data can be analyzed to detect whether the data itself drifts with respect to the reference data (e.g., data used for training). Various approaches can be used to compare imaging data sets, such as principal component analysis (PCA), cross-correlation, Facebook FAISS, or machine learning models trained to measure similarity between two datasets. Similarly, an output of a machine-learning model can be analyzed to detect whether it deviates from its prior statistical distribution over time. Dataset similarity measures can be combined with model output deviation measures to produce a global measure of likelihood that model outputs are deviating and may need to be reviewed. This can be done with a threshold applied on several metrics, or more complex techniques such as another machine learning model for model quality surveillance or drift detection. If a drift probability is high enough, a redefinition of the reference dataset can be triggered, such as including retraining of the models. The retraining can be done from scratch, or with transfer learning. An example of an overall topology for application of machine learning models to acoustic inspection is shown illustratively in FIG. 8. FIG. 5B illustrates generally a technique 580, such as a machine-implemented method, for deploying a machine learning model including drift monitoring. Acquired acoustic inspection imaging data 524B can be compared with a reference imaging data set at 558, such as compared with a training data set 552B. In acquired acoustic inspection data can be screened for consistency with a reference population of images. An indication that the acquired acoustic inspection imaging data 524B is deviating in some manner (e.g., according to one or more metrics) can provide a drift indication for drift monitoring at 564. Drift monitoring at 564 can also include evaluation of outputs from deployed machine-learning models applied at 562. For example, statistical or other metrics can be applied to compare current inferences with recent prior inferences, or other indicia. If at 566 the acquired acoustic inspection imaging data 524B or the output of the machine-learning models applied at 562 is drifting, a flag or other declaration can be generated at 568, such as taking the automated flaw detection or anomaly detection models offline, or triggering other action such as retraining, switching to a different model, etc. Otherwise, flaw detection or anomaly detection (or both) can continue at 572.

Drift monitoring or other comparisons between populations of acquired acoustic inspection images can be performed using various approaches. For example, FIG. 5C shows an illustrative example that can include using a statistical distribution as an indication of a degree of similarity between a population of images corresponding to acquired acoustic imaging data versus a reference population of images, where in the example of FIG. 5C, the acquired acoustic imaging data and the reference population are similar. If an input image is provided to a reconstruction method, such as based on Principal Component Analysis (PCA) or, for example, an autoencoder trained using a reference population of images, a reconstruction residue value can be determined by comparing an output of the autoencoder with the input image. If such a determination is performed on a group of input images, a distribution of reconstruction residue values is obtained. FIG. 5C shows a histogram of such values. The difference between the reconstructed and original images is a metric of the inability of the reconstruction method to reconstruct an image from a very different dataset. The residual can be, for example, a Mean Squared Error (MSE) of the difference between the original image and the reconstructed image. The distributions can be obtained by binning multiple such residues.

Inspection of FIG. 5C shows that the distributions overlap significantly, and such similarity can be evaluated analytically such as using a Kolmogorov-Smirnov (KS) test to compare a new data set of imaging data (“NEW DATASET”) against a reference data set used for training (annotated “REF DATASET TRAIN”). Generally, the KS test can be used to provide a numerical metric indicative of a difference in sample distributions, where a lower magnitude indicates greater similarity. In this example, a KS index, KS=0.11, similar to a validation data set versus the reference data set (annotated “REF DATASET VALID”). By contrast, FIG. 5D shows an illustrative example that can include using a statistical distribution as an indication of a degree of similarity between a population of images corresponding to acquired acoustic imaging data versus a reference population of images, where in the example of FIG. 5C, the acquired acoustic imaging data and the reference population are different indicating either drift or another anomaly. A threshold can be set for a KS index value, and if a set of input images is below the value, then drift may not be indicated. In FIG. 5D, the KS index value for the data annotated “NEW DATASET” is KS=0.80, which is significantly greater and corresponds to the different morphology of the “NEW DATASET” distribution of FIG. 5D as compared to the “REF DATASET TRAIN” distribution.

Generally, as shown in FIG. 5C and FIG. 5D, KS indices are computed for three examples: the REF DATASET TRAIN against itself (which, if the similarity metric is working properly should be KS~0); the reference data set versus a data set that is made of samples that correspond to the training data set, but which were not included in the training data set (“REF DATASET VALID,” for validation, with KS-non-zero, showing a “normal” deviation from KS=0, but not indicative of unacceptable deviation); and the reference data set versus a new data set (NEW DATASET).

The approach shown in FIG. 5C and FIG. 5D is one approach, and other techniques can be used to determine whether imaging data is deviating from prior data used for training or prior data obtained during earlier inspection. FIG. 5E shows an illustrative example that can include using principal component analysis (PCA) to generate a reconstruction quality metric as an indication of a degree of similarity between a population of images corresponding to acquired acoustic imaging data versus a reference population of images, and plotted versus index location (e.g., end-view location). In FIG. 5E, new data that is within plus-or-minus one standard deviation of earlier reconstruction quality metrics as indicated by 100 PCA dimensions can be deemed as “similar” to the reference population. As shown in FIG. 5E, a majority of the samples are outside such a criterion and can be considered dissimilar, indicating that drift or other anomaly has occurred (and also as indicated by a shifted mean and standard deviation).

As an illustrative example for performing such analysis, a set of D vectorized “flattened” images can be established, {I_{d}}. A PCA determination can be made represented by the expression:

PCA({I_{d}})={C,V,<I>} EQN. 1

A partial image reconstruction (e.g., using N coefficients) can be performed, and represented as follows:

$${\tilde{I}}_{d} = 〈 I 〉 + {\sum }_{n = 0}^{N} {C}_{dn} {v}_{n} \qquad EQN . 2$$

$$〈 I 〉 = \frac{1}{D} {\sum }_{d = 0}^{D} {I}_{d} \qquad EQN . 2$$

Validation and test sets of vectorized images can be established, {J_{d}}, and coefficients from PCT basis vector components can be computed:

$${D}_{dn} = {v}_{n}^{T} \cdot ( {J}_{d} - 〈 I 〉 ) \qquad EQN . 4$$

Partial image reconstruction (e.g., using N coefficients) can be performed, represented as follows:

$${\tilde{J}}_{d} = 〈 I 〉 + {\sum }_{n = 0}^{N} {D}_{dn} {v}_{n} \qquad EQN . 5$$

A reconstruction residue metric can then be determined (using Euclidean distance in this example):

$${res}_{d} = \frac{1}{P} {\vert {J}_{d} - {\tilde{J}}_{d} \vert}^{2} = \frac{1}{P} {\vert {J}_{d} - 〈 I 〉 \vert}^{2} - \frac{1}{P} {\sum }_{n = 0}^{N} {D}_{dn}^{2} \qquad EQN . 6$$

In one definition, a reconstruction quality can be modeled as a normalized difference between an original image and reconstructed image. The plot of FIG. 5E presents a series of residual values that, when binned, provide a distribution similar to that shown in FIG. 5C or FIG. 5D. Showing the residues of individual samples as in FIG. 5E can highlight non-stationarities in samples plotted with respect to the index location, showing that parts of the data could agree with the reference data set while some parts may not, as the probe is used to obtain a series of end views at different index locations. Poorly reconstructed images, “outlier images,” could then be further inspected individually, and possibly included as part of the reference data set to take into account normal/acceptable fluctuations, such as used for re-training a corresponding model. By contrast, such outliers could also be indicative of instrument configuration, manufacturing process, or material anomalies that warrant separate attention.

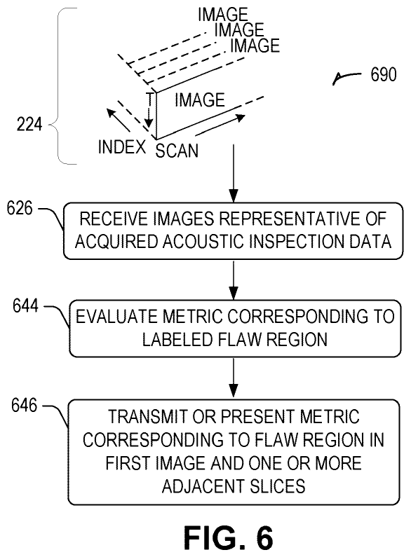

As discussed above, drift monitoring can assist in identifying situations where a machine-learning-based flaw detection or anomaly detection may be hindered by deviation in input imaging data characteristics versus imaging data used for training. Model robustness can be evaluated, or training data can be improved such as by performing data assessment on flaw annotations in imaging data, such as to evaluate a quality of such annotations (e.g., evaluation whether actual flaws are likely to exist or whether a flaw region was falsely or otherwise incorrectly labeled). For example, FIG. 6 illustrates generally a technique 690, such as a machine-implemented method, for assessing quality of a flaw annotation in acoustic imaging data.

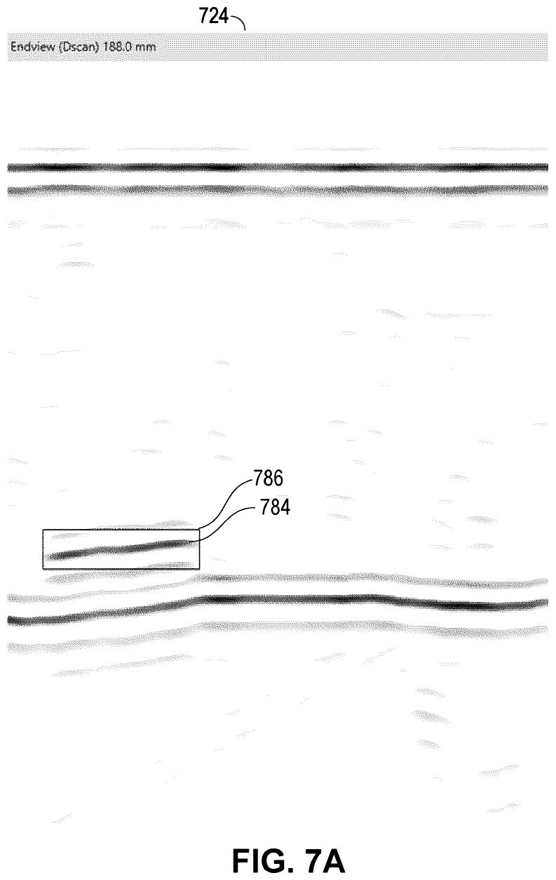

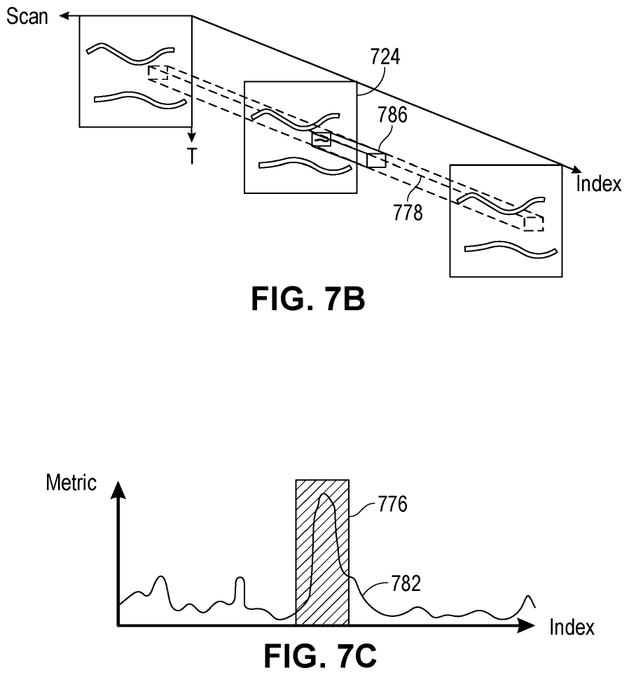

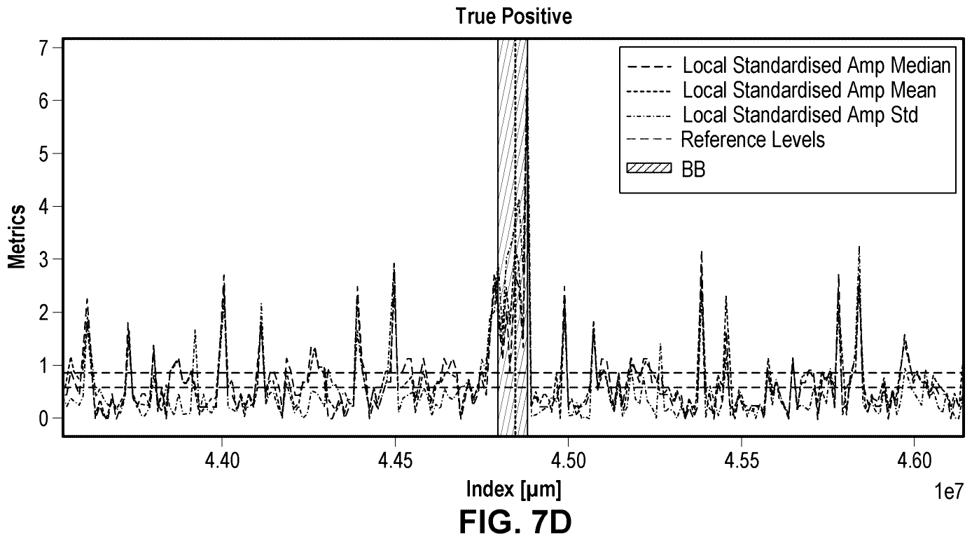

In the example of FIG. 6, one or more images 224 representative of annotated acquired acoustic inspection data can be received at 626 (e.g., with such annotation indicative of a flaw). At 644, a metric can be evaluated corresponding to the flaw region in a first image. At 646, the metric can be transmitted or presented, such as associated with the first image (or in addition, the one or more adjacent slices), or, for example, the imaging data can be updated such as disqualifying a respective image from use for training if the flaw annotation is deemed likely to be false. As an illustration, FIG. 7D below shows different types of metrics that can be numerically computed for evaluation of whether the flaw annotation is likely false or likely valid, such as extending to multiple images corresponding to regions adjacent the image having the annotated flaw (e.g., adjacent image slices).

FIG. 7A shows an illustrative example of an image 724 corresponding to an acoustic acquisition (e.g., a D-scan image), and a corresponding flaw 784. The image of FIG. 7A is representative of a flaw that may be annotated by a human when reviewing acoustic inspection imaging data. A bounding box 786 can be established around the flaw 784, such as for use in evaluating a quality of the annotation. FIG. 7B shows an illustrative example of image slices adjacent to the image 724 having the flaw annotation, and a corresponding extension 778 of a bounding box 786 as shown in FIG. 7A extended to one or more adjacent slices in the index direction, such as for assessing quality of a flaw annotation using a technique as described in FIG. 6. FIG. 7C shows an illustrative example comprising a value of a metric 782 versus index location, with a range of index location values corresponding to the extension of the bounding box 776 of FIG. 7B in the index axis, and locations extending beyond the bounding box in either direction. An indication that a flaw is likely a valid flaw can include that the metric exceeds a specified threshold at other index locations within the bounding box 776. An indication that a flaw is likely falsely annotated can include that that the metric at the exact index location of the annotated image is similar to values of the metric elsewhere, including within the bounding box 776. Generally, actual flaws are indicated by abnormal fluctuation in one or more metrics with respect to surrounding regions. In the example of FIG. 7D, below, the metrics (e.g., median, mean, and standard deviation in a bounding box) are larger in a sustained manner over the labelled bounding box than the background “noise” floor elsewhere. Reference levels for respective metrics can be extracted (e.g., a median of peak values) and can provide a threshold above which one can consider the data as abnormal, and indicative of a probable flaw.

FIG. 7D shows an illustrative example comprising a plot of different metric values that can be used for assessing a quality of a flaw annotation, such as including an indication of a range of index location values corresponding to the extension of the bounding box of FIG. 7B in the index axis. Examples shown in FIG. 7D include standardized amplitude median value within a specified localized region, standardized amplitude mean within the localized region, standardized amplitude standard deviation within the localized region, along with one or more reference levels such as corresponding to a noise floor or other reference. For example, as mentioned above, a respective reference level can be computed as a median of peak values for a respective metric. Such a reference level can then be used as a threshold as mentioned above.

FIG. 8 shows an architecture 895 and related workflows that can include establishing training data 824B for training one or more machine learning models, assessing data at 858 to be used as an input to one or more such machine learning models (e.g., a flaw detection model 834 or anomaly detection model 836, or other models), applying one or more such models, and assessing an output from such models at 888.

As discussed above, the training data 824B can be annotated, such as to support a supervised learning approach, and such data can be augmented at 856. Acquired acoustic inspection imaging data 824A can be obtained in relation to non-destructive inspection of a structure such as a composite structure (e.g., an airfoil such as a portion of an aircraft or a wind turbine blade). The composite structure can be inhomogeneous, such as including different material layers having different associated acoustic propagation characteristics (e.g., group velocity). Inspection can include obtaining D-scan imaging (or using other imaging formats such as A-scan, B-scan, C-scan, S-scan), as discussed elsewhere herein. Data assessment at 858 can be used to evaluate whether the acquired acoustic inspection imaging data 824A deviates from training data 824B used for training the flaw detection model 834 or the anomaly detection model 836.

Data assessment can be performed at 888, such as using another machine-learning-based model or other approaches such as heuristics or numerical parameters (e.g., quality metrics at 892) to determine whether model performance is deteriorating, drifting, or another anomaly exists. An indication of drift or other anomaly from data assessment at 888 can be used to trigger review or trigger model modification, such as retraining or selecting a different model. A presentation can be generated at 894, such as contemporaneously presenting outputs from the flaw detection model 834 and the anomaly detection mode 836, or other information such as indications of drift or other quality metrics. Use of the approaches discussed above can enhance inspection throughput (e.g., shorten review and annotation time) by automating identification and classification of flaws, or identifying other pertinent information such as inspection configuration anomalies. Use of the approaches discussed above can also provide cross-checking to determine when machine-learning-based detection models may be drifting or may be unsuitable because characteristics of the input data are indicated as dissimilar to training data.

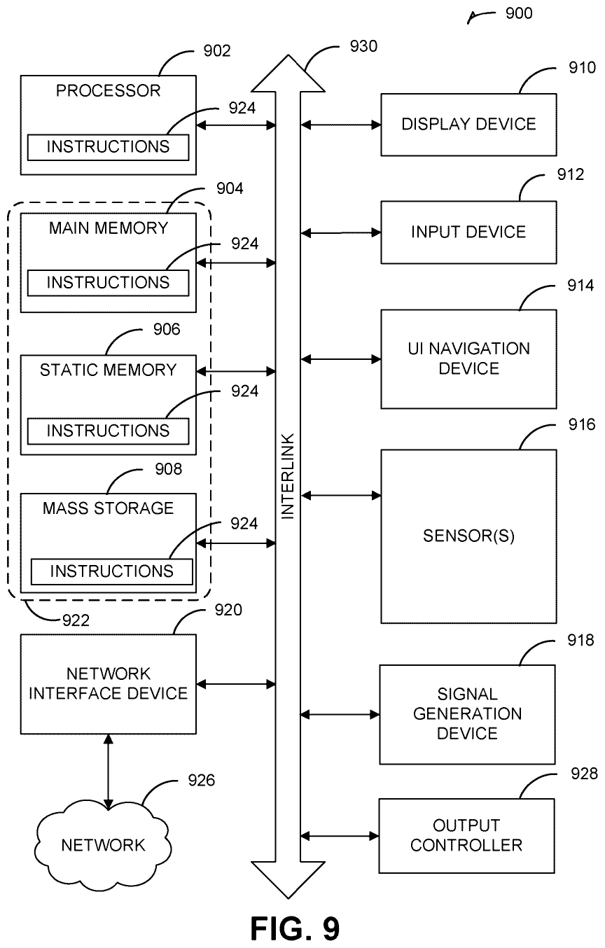

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interlink 930 (e.g., link or bus), as some or all of these components may constitute hardware for systems or related implementations discussed above.

Generally, the hardware processor 902 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 904 include Random Access Memory (RAM), and semiconductor memory devices, which may include storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912, and UI navigation device 914 may be a touch-screen display. The machine 900 may include a mass storage device 908 (e.g., drive unit), a signal generation device 918 (e.g., a speaker), a network interface device 920, and one or more sensors 916, such as a global positioning system (GPS) sensor, compass, accelerometer, or some other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 908 may comprise a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 908 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 924.

An apparatus of the machine 900 includes one or more of a hardware processor 902 (e.g., a central processing unit (CPU), a graphics processing unit (GPU), a hardware processor core, or any combination thereof), a main memory 904 and a static memory 906, sensors 916, network interface device 920, antennas, a display device 910, an input device 912, a UI navigation device 914, a mass storage device 908, instructions 924, a signal generation device 918, or an output controller 928. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 924 may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 920 includes one or more physical jacks (e.g., Ethernet, coaxial, or other interconnection) or one or more antennas to access the communications network 926. In an example, the network interface device 920 includes one or more antennas to wirelessly communicate using at least one of single-input multiple-output (SIMO), multiple-input multiple-output (MIMO), or multiple-input single-output (MISO) techniques. In some examples, the network interface device 920 wirelessly communicates using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes

Each of the non-limiting aspects in this document can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method, comprising:
receiving a first image representative of acquired acoustic inspection data, the first image comprising pixel values corresponding to received acoustic echo amplitude versus time within an object under test, and versus a scan axis;
generating a flaw map indicative of probable flaw locations corresponding to respective locations in the first image using the received first image and a neural-network-based flaw detector; and
generating an indication versus location in the scan axis indicative of an anomaly using the received first image and a neural-network-based anomaly detector.

2. The machine-implemented method of claim 1, comprising receiving multiple images of acquired acoustic inspection data, corresponding to adjacent slices within the object under test; and
wherein generating the flaw map indicative of probable flaw locations in the first image includes using one or more adjacent slices from amongst the multiple images along with the first image as an input to the neural-network-based flaw detector.

3. The machine-implemented method of claim 1, wherein the indication versus location in the scan axis indicative of the anomaly comprises an anomaly score.

4. The machine-implemented method of claim 3, wherein determining the anomaly score comprises comparing an output image generated by the neural-network-based anomaly detector with the image representative of acquired acoustic inspection data or wherein determining the anomaly score is provided as an output of the neural-network-based anomaly detector.

5. (canceled)

6. The machine-implemented method of claim 3, comprising at least one of generating an alert or flagging a location in the scan axis where the anomaly score exceeds a specified threshold.

7. The machine-implemented method of claim 1, wherein the anomaly comprises an inspection configuration anomaly other than a flaw defined by the neural-network-based flaw detector.

8. (canceled)

9. The machine-implemented method of claim 1, wherein the flaw map comprises a binary indication of flaw location by generating a single-bit encoded flaw map.

10. The machine-implemented method of claim 1, wherein the flaw map comprises at least one of: an indication of a type of flaw by using a respective pixel characteristic corresponding to each respective type of flaw or an indication of a probability of a flaw by using a respective pixel characteristic.

11-12. (canceled)

13. The machine-implemented method of claim 1, wherein the flaw map is generated by aggregating results from two or more models amongst multiple models.

14. The machine-implemented method of claim 13, wherein a respective model amongst the multiple models comprises at least one of an autoencoder, an image segmentation model, and a flaw classifier

15. The machine-implemented method of claim 1, comprising determining whether a plurality of input images representative of acquired acoustic inspection data differ from a reference population of images.

16. The machine-implemented method of claim 15, wherein the reference population of images corresponds to images used for training the neural-network-based flaw detector or the neural-network-based anomaly detector, or both.

17. The machine-implemented method of claim 1, wherein the first image representative of acquired acoustic inspection data is screened for consistency with a reference population of images prior to use with either the neural-network-based flaw detector or the neural-network-based anomaly detector.

18. The machine-implemented method of claim 1, wherein the first image comprises a D-scan image, a C-scan image, or a B-scan image.

19. (canceled)

20. The machine-implemented method of claim 1, wherein the object under test comprises a composite material.

21. The machine-implemented method of claim 1, wherein the neural-network-based flaw detector is trained using a supervised learning approach.

22. The machine-implemented method of claim 1, wherein the neural-network-based anomaly detector is trained using an unsupervised learning approach.

23. The machine-implemented method of claim 1, comprising contemporaneously presenting the flaw map and the indication versus location of the anomaly.

24. A system, comprising:
at least one processor circuit communicatively coupled with at least one memory circuit comprising instructions that, when executed by the at least one processor circuit, cause the system to perform a machine-implemented method comprising:
receiving a first image representative of acquired acoustic inspection data, the first image comprising pixel values corresponding to received acoustic echo amplitude versus time within an object under test, and versus a scan axis;
generating a flaw map indicative of probable flaw locations corresponding to respective locations in the first image using the received first image and a neural-network-based flaw detector; and
generating an indication versus location in the scan axis indicative of an anomaly using the received first image and a neural-network-based anomaly detector.

25. A machine-implemented method, comprising:
receiving multiple images of acquired acoustic inspection data including a label defining a flaw region in a first image amongst the multiple images, the multiple images comprising pixel values corresponding to received acoustic echo amplitude versus time within an object under test, and versus a scan axis;
evaluating a metric corresponding to the flaw region in the first image and a corresponding region in one or more adjacent slices from amongst the multiple images to define a bounding region extending in three dimensions; and
transmitting or presenting the metric for use in determining whether the label defining the flaw region corresponds to a real flaw.

26-30. (canceled)
